(19) United States
(12) Patent Application Publication
(10) Pub. No.: US 2016/0327847 A1
(43) Pub. Date: Nov. 10, 2016

(54) SELF-BALANCE TRIPOD HEAD FOR GYROSCOPE

(71) Applicant: ZERO UAV (BEIJING) INTELLIGENCE TECHNOLOGY CO., LTD., Beijing (CN)

(72) Inventors: Jianjun YANG, Beijing (CN); Hongtao SUN, Beijing (CN)

(73) Assignee: ZEROTECH (SHENZHEN) INTELLIGENCE ROBOT CO., LTD., SHENZHEN (CN)

(21) Appl. No.: 15/109,272

(22) PCT Filed: Mar. 24, 2015
(86) PCT No.: PCT/CN2015/074937

§ 371 Date: Jun. 30, 2016

(30) Foreign Application Priority Data
Mar. 24, 2014 (CN) 201420135106.8

(51) Int. Cl. G03B 15/00; B64C 39/02; G03B 17/56; F16M 11/06; F16M 11/20; F16M 11/18; B64D 47/08; F16M 13/02

(52) U.S. Cl. CPC G03B 15/006; B64D 47/08; B64C 39/024; F16M 13/02; F16M 11/06; F16M 11/2035; F16M 11/18; G03B 17/561; B64C 2201/127; F16M 2200/041; F16M 2200/044

(57) ABSTRACT

A gimbal includes a base and a fixing support rotatably provided on the base; the fixing support includes a support plate, a first mounting seat and a second mounting seat, the support plate is rotatably connected to the base; the first mounting seat and the second mounting seat are respectively fixed at both ends of the support plate; and the support plate, the first mounting seat and the second mounting seat collectively construct a U-shaped structure. An unmanned aerial vehicle including the gimbal is also disclosed.

### TECHNICAL FIELD

The present application is related to a gimbal and an unmanned aerial vehicle including the same.

### BACKGROUND

A gimbal is a support component used for mounting and fixing an imaging device such as a camera, and is divided into a stationary type and an electric motorized type. A stationary gimbal is suitable for the situation with a relative small monitor range, after the camera has been mounted on the stationary gimbal, the camera can be adjusted in terms of its horizontal rotation angle and its pitch angle, and when the final attitude is achieved, it can be put into operation only after the adjusting mechanism is locked.

An electric motorized gimbal is suitable for scanning, shooting and monitoring a relative large range. For the situation with high requirements upon operation, during the running of the gimbal, because a carrier body (e.g., an aerial vehicle, a ship, or the like) is subjected to high frequency vibration and low frequency jitter, for addressing this problem, a gyroscopic self-balance gimbal having three degrees of freedom has been put into the market, to compensate for the stability problem incurred from the above variation. In this kind of gimbal, attitude variation of the imaging device is detected by an electronic device, to control a servo to carry out reverse compensation, so as to achieve stable image taking.

However, a known gimbal has a complex structure, not only has high manufacturing cost, but also has large weight, and therefore it imposes high requirements on the aerial vehicle.

### SUMMARY

An object of the present utility application is to provide a gyroscopic self-balance gimbal with simple structure, high stability, and small weight.

According to an aspect of the present utility application, a gyroscopic self-balance gimbal includes: a base configured to be fixed with a carrier body, a first support rotatably connected with the base and rotatable on a Z axis direction, a second support rotatably connected to the first bracket and rotatable on an X axis direction, and a third support rotatably connected to the second bracket and rotatable on a Y axis direction for carrying an imaging device; the third support includes a support plate for rotatably connecting with the second support, and includes an upper mounting seat and a lower mounting seat respectively fixed on both ends of the support plate, the support plate, the upper mounting seat, and the lower mounting seat collectively construct a space in a U-shaped structure for fixing the imaging device.

Preferably, the first support is an L-shaped arm including a first arm for connecting with the base and a second arm for connecting with the second support.

Preferably, a first support electric motor is provided on the first support to drive the second support to rotate.

Preferably, a mounting groove is provided at a free end of the second arm and a mounting plug is provided on the first support electric motor to fit with the mounting groove.

Preferably, the mounting groove and the mounting plug are fixed by screws.

Preferably, the second support is an L-shaped arm including a third arm for connecting with the first support and a fourth arm for connecting with the third support.

Preferably, a second support electric motor for driving the third support to rotate is provided on the second support.

Preferably, a mounting groove is provided at a free end of the fourth arm and a mounting plug for fitting with the mounting groove is provided on the second support electric motor.

Preferably, the mounting groove and the mounting plug are fixed by screws.

Preferably, a base electric motor for driving the first support to rotate is provided on the base.

The present utility application has advantageous technical effect in that the structure and arrangement of the present utility application allow that the gimbal has a relative simple structure and small weight, and the electric motor controls the gimbal to carry out dynamic compensation in an easier way.

Other features and advantages of the present utility application will be apparent from the following description of the exemplary embodiments of the present utility application with reference to the attached drawings.

### DESCRIPTION OF THE ATTACHED DRAWINGS

The companying drawings, included in the specification as a part thereof, describe the embodiments of the present utility application, and are used to explain the principle of the present utility application, together with the specification.

FIG. 1 shows a schematic structure diagram of the gimbal according to the present utility application;

FIG. 2 shows a schematic structure diagram of the gimbal according to the present utility application in a case where an imaging device is not carried on;

FIG. 3 shows a schematic structure diagram of a third support shown in FIG. 1;

FIG. 4 shows a schematic structure diagram of the third support and the imaging device;

FIG. 5 shows a partially explored diagram of a second support in the gimbal according to the present utility application; and

FIG. 6 shows an explored diagram of a mounting seat according to the present utility application.

### DETAILED DESCRIPTION

Various exemplary embodiments of the present utility application will now be described in detail with reference to the attached drawings. It is to be noted that the relative arrangement, numbers, expressions and values of components and steps set forth in these embodiments are not intended to limit the scope of the present utility application, unless otherwise specified.

In fact, the following description of at least one exemplary embodiment is illustrative, and does never limit the scope of the present utility application and its application and usage.

The technology and equipment well known to the person skilled in the related art will not be discussed in detail, however, in some cases, the technology and equipment should be deemed as a part of the present specification.

In all examples shown and discussed herein, any particular values or amounts should be construed as merely illustrative, rather than as limitation. Therefore, other examples of the exemplary embodiments may have different values or amounts.

It is to be noted that like symbols and letters are used to indicate like components in the following figures, and therefore, once a certain component is defined in one figure, its discussion in the subsequent figures will be omitted.

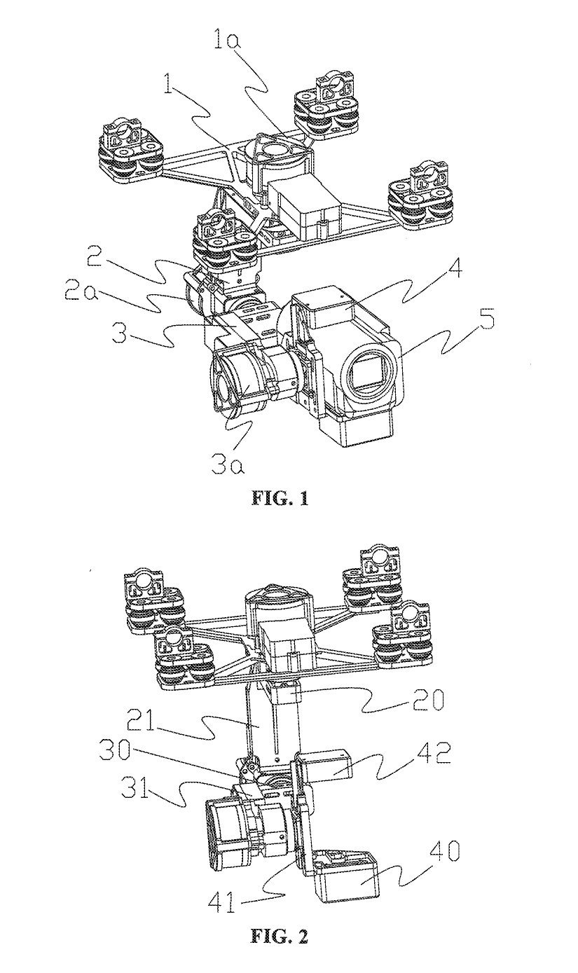

With reference to FIG. 1 and FIG. 2, the present utility application discloses a gyroscopic self-balance gimbal, the gimbal includes a base 1 capable of being fixed to a carrier body which may be a unmanned aerial vehicle, an automobile, a ship, or the like, the base 1 is rotatably connected with a first support 2 by a base electric motor 1a, the first support 2 is rotatably connected with a second support 3 by a first support electric motor 2a, and the second support 3 rotates a third support 4 for carrying an image apparatus 5 through a second support electric motor 3a, whereby, the first support 2, the second support 3, and the third support 4 can be independently rotated respectively on a Z axis, an X axis, and a Y axis to achieve dynamic balance compensation of the gimbal.

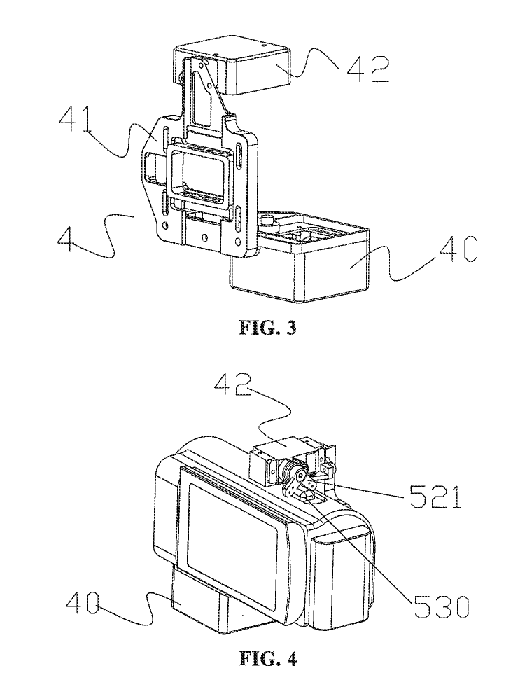

With reference to FIG. 3, the third support 4 of the present utility application includes a support plate 41 for rotatably connecting with the second support 3, and includes an upper mounting seat 42 and a lower mounting seat 40 respectively fixed on both ends of the support plate 41 respectively, and the support plate 41, the upper mounting seat 42 and the lower mounting seat 40 collectively construct a space in a U shaped structure for fixing an imaging device 5. With this structural arrangement, it allows the gimbal to have relative simple structure and small weight, and allow electric motors to control the gimbal to carry out dynamic compensation in an easier way.

In the present utility application, the first support 2 is an L-shaped arm, and includes a first arm 20 for connecting with the base 1 and a second arm 21 for connecting the second support 3.

The first support 2 may have a same structure as the second support 3, that is, is also an L-shaped arm. In order to distinguish the second support from the first support 2, the second support 3 includes a third arm 30 for connecting with the first support and a fourth arm 31 for connecting with the third support 4.

In the present utility application, by employing an L-shaped arm design for the first support 2 and the second support 3, the structure of the gimbal can be further simplified, and moreover, the stability of the whole gimbal is not affected, and the control on the respective supports by the electric motors is further facilitated.

The present utility application further provides mounting structures for the electric motors in the gimbal. Taking the first support electric motor 2a as an example, its mounting structure is as follows: in the first support 2, a free end of the second arm 21 is provided with a mounting groove, a mounting plug for fitting with the mounting groove is provided on the first support electric motor 2a, and the mounting plug and the mounting groove are fixed by screws. In this way, the first support electric motor 2a is mounted on the free end of the second arm 21, so that the first support electric motor 2a can be mounted in a simple and stable manner.

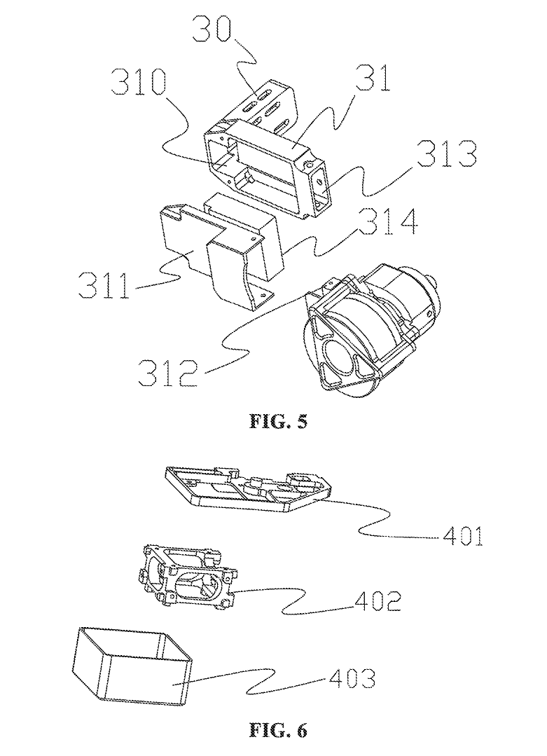

The second support electric motor 3a has a same mounting structure as that of the first support electric motor 2a. With reference to FIG. 5, the second support 3 is an L-shaped arm, a free end of the fourth arm 31 is provided with a mounting groove 313, and a mounting plug 312 for fitting with the mounting groove 313 is provided on the second support electric motor 2a. When the electric motor is mounted, the mounting plug 312 of the second support electric motor 2a is inserted into the mounting groove 313 on the end of the fourth arm 31, and is fixed therewith by screws.

The present utility application further provides a mounting structure for an electronic speed governor in the gimbal. With reference to FIG. 5, in the second support 3, the fourth arm 31 is provided, at a sidewall thereof, with a recess 310 in which the electronic speed governor 314 is provided, and further includes a cover 311 for enclosing the recess 310. In this mounting structure for the electronic speed governor, the electronic speed governor 314 is embedded in the fourth arm 31, and is enclosed by the cover 311; in this way, not only the structure is compact, but also the electronic speed governor is well protected.

The mounting structure for the electronic speed governor on the first support 2 is same as that on the second support 3; at a sidewall of the second arm 31 of the first support 2, a recess in provided, the electronic speed governor is provided in the recess, and a cover for enclosing the recess is further included. Preferably, the recess is arranged along a lengthwise direction of the second arm.

The present utility application further provides a mounting structure for a gyroscope in the gimbal. The lower mounting seat 40 is provided with an inner cavity in which the gyroscope for controlling attitude of the gimbal is provided. Specifically referring to FIG. 6, the lower mounting seat 40 includes a housing 403 provided with an inner cavity, the gyroscope is mounted in the housing 430, and is enclosed by a cover 401. With this structure, not only the gyroscope is well protected, but also the whole structure becomes simple and compact. Preferably, an IMU (inertial measurement unit) frame 402 complying with the shape of the inner cavity is further provided in the inner cavity, the IMU frame is known in the related art, and will not be further described herein.

The present utility application further provides a driving assembly for adjusting a lens in the gimbal. With reference to FIG. 4, the imaging device 5 is provided with a button 530 for adjusting the lens thereof, the third support 4 is provided with a servo, and an output shaft of the servo is provided with a V-shaped fork 530 for moving the button back and forth. In this way, the servo is controlled to move as necessary, so that the V-shaped folk 530 drives the button to move to adjust the lens, and thus the aerial shooting performance is improved.

While some specific embodiments of the present utility application have been described in detail above by way of examples, it is appreciated to the person skilled in the art that these examples are only for illustrating, rather than limiting the scope of the present utility application. It should be understood by the person skilled in the art that modification can be made on the above embodiments without departing from the scope and spirit of the present utility application. The scope of the present utility application is defined by the appended claims.

1-10. (canceled)

11. A gimbal, including a base and a fixing support rotatably provided on the base, wherein the fixing support includes a support plate, a first mounting seat and a second mounting seat,
the support plate is rotatably connected to the base;
the first mounting seat and the second mounting seat are respectively fixed at both ends of the support plate; and
the support plate, the first mounting seat and the second mounting seat collectively construct a U-shaped structure.

12. The gimbal according to claim 11, further including an electric motor, wherein the electric motor is provided on the base, the support plate of the fixing support is rotatably connected with the electric motor so as to rotatably connected to the base, and the fixing support is driven by the electric motor to rotate.

13. The gimbal according to claim 11, further including a first support and a second support, wherein the first support is rotatably connected to the base;
the second support is rotatably connected to the first support; and
the support plate of the fixing support is rotatably connected to the second support so as to rotatably connected to the base.

14. The gimbal according to claim 13, further including a base electric motor, wherein the base electric motor is provided on the base and is rotatably connected with the first support, whereby the first support is rotatably connected to the base; and
the base electric motor is capable of driving the first support to rotate about a first rotation axis.

15. The gimbal according to claim 14, further including a first electric motor, wherein the first electric motor is provided on the first support and is rotatably connected with the second support, whereby the second support is rotatably connected to the first support; and
the first electric motor is capable of driving the second support to rotate about a second rotation axis, and the first rotation axis is different from the second rotation axis.

16. The gimbal according to claim 15, wherein the first support includes a first arm and a second arm connected with each other to construct an L shape,
the first arm is rotatably connected with the base electric motor, whereby the first support is rotatably connected with the base;
the first support is capable of being driven by the base electric motor to rotate; and
the second arm is configured to mount the first electric motor.

17. The gimbal according to claim 14, further including a second electric motor, wherein the second electric motor is provided on the second support and is rotatably connected with the support plate of the fixing support, whereby the support plate of the fixing support is rotatably connected to the second support; and
the second electric motor is capable of driving the fixing support to rotate about a third rotation axis, and the third axis is different from both the first rotation axis and the second rotation axis.

18. The gimbal according to claim 17, wherein the second support includes a third arm and a fourth arm connected with each other to construct an L shape,
the third arm is rotatably connected with the first electric motor, and whereby the second support is rotatably connected with the first support,
the second support is capable of being driven by the first electric motor to rotate; and
the fourth arm is configured to mount the second electric motor.

19. The gimbal according to claim 18, wherein the first rotation axis, the second rotation axis and the third rotation axis are perpendicular to each other.

20. The gimbal according to claim 13, further including a second electric motor, wherein the second electric motor is fixed on the second support and is rotatably connected with the support plate of the fixing support, whereby the support plate of the fixing support is rotatably connected with the second support, and
the second electric motor is capable of driving the fixing support to rotate.

21. The gimbal according to claim 20, wherein the second support includes a third arm and a fourth arm connected with each other to construct an L shape;
the third arm is rotatably connected with the first support, whereby the second support is rotatably connected to the first support;
the second support is capable of being driven by the first electric motor to rotate; and
the fourth arm is configured to mount the second electric motor.

22. The gimbal according to claim 21, wherein a rotation axis about which the first support is rotated, a rotation axis about which the second support is rotated and a rotation axis about which the fixing support is rotated are perpendicular to each other.

23. The gimbal according to claim 11, wherein the second mounting seat is provided with an inner cavity therein.

24. The gimbal according to claim 23, further including a gyroscope, wherein the gyroscope is provided in the inner cavity of the second mounting seat.

25. The gimbal according to claim 11, wherein a servo is provided on the first mounting seat.

26. The gimbal according to claim 25, wherein the servo includes an output shaft and a fork provided on an end of the output shaft.

27. The gimbal according to claim 26, wherein the fork is of V-shaped.

28. An unmanned aerial vehicle, including a gimbal, wherein the gimbal includes a base and a fixing support rotatably provided on the base,
the fixing support includes a support plate, a first mounting seat and a second mounting seat,
the support plate is rotatably connected to the base, the first mounting seat and the second mounting seat are respectively fixed at both ends of the support plate,
the support plate, the first mounting seat and the second mounting seat collectively construct a U-shaped structure.

29. The unmanned aerial vehicle according to claim 28, further including an imaging device, wherein the imaging device is fixed between the first mounting seat and the second mounting seat of the U-shaped structure.

30. The unmanned aerial vehicle according to claim 29, wherein the first mounting seat is provided with a servo thereon, the servo includes an output shaft and a fork provided on an end of the output shaft, the imaging device includes a button, the fork is configured to move the button.
